(19) United States
(12) Patent Application Publication
(10) Pub. No.: US 2017/0163712 A1
(43) Pub. Date: Jun. 8, 2017

(54) PTP INTERACTION ASSOCIATION SYSTEM ARRANGING URL ELECTRONIC DATA DEVICE

(71) Applicant: Yimwai YAU, Hong Kong (CN)

(72) Inventor: Yimwai YAU, Hong Kong (CN)

(21) Appl. No.: 15/309,057

(22) PCT Filed: Apr. 30, 2015
(86) PCT No.: PCT/CN2015/078043

§ 371 Date: Feb. 6, 2017

(30) Foreign Application Priority Data
May 4, 2014 (CN) 201420234008.X
May 5, 2014 (CN) 201420237438.7
May 5, 2014 (CN) 201420237440.4
Sep. 5, 2014 (CN) 201420525002.8

(51) Int. Cl. H04L 29/08; H04W 4/00

(52) U.S. Cl. CPC H04L 67/02; H04L 67/12; H04W 4/008; H04W 84/12

(57) ABSTRACT

The present invention relates to a kind of Internet of Things technology, and in particular to a PTP interactive interconnected system for setting a URL electronic data device to provide technical support enabling achieved Internet Plus for a traditional industry. The system comprises a communication terminal product supporting the PTP interactive interconnected system, a URL electronic data device, and a plane mark, wherein the communication terminal product supports the input of a numeric character corresponding to the plane mark; and an operating system of the communication terminal product receives an instruction from the plane mark, calls out paired URL electronic data stored in the URL electronic data device, and sends a relevant request to a back-end server after processing the paired URL electronic data, and the back-end server returns an electronic file associated with the URL electronic data according to the relevant request.

### BACKGROUND OF THE INVENTION

1. Technical Field

The present invention relates to a kind of Internet of Things technology, and in particular to a PTP interactive interconnected system for setting a URL electronic data device to provide technical support enabling achieved Internet Plus for a traditional industry.

2. Description of Related Art

An advertising product based on traditional media is significantly behind that of electronic media in transmission capability, nevertheless, it is absolutely not the fact that “an ultimate form of mass media may replace any one of media such as traditional print media, traditional broadcasting, traditional television and traditional Internet”, as promoted by some people.

Information accessibility includes two major categories: one is network accessibility, and the construction of website accessibility falls under the category of network accessibility issues; and the other is electronics and information technology accessibility, which is to address seamless cross-media interconnection.

The Internet Society of China provides a definition as follows: information accessibility refers to any person (including the healthy, the disabled, the young and the old) under any circumstances being able to get access to and make use of information equally and conveniently without barriers.

If a smart phone is used to log on to the Internet for the information related to a print media product and get access to richer relevant data through extension, an association technology is a necessary condition that cannot be crossed out.

At present, it is a mainstream concept to enable offline and online connection for a plane media product with the solution of two-dimensional barcode/quick response code patterns in the market. Even though a mature product and industry chain has formed regarding the two-dimensional barcode/quick response code patterns, there are many restrictions on the technical use conditions in actual operation, and this refer to the following restrictions:

1. a smart phone can scan a two-dimensional barcode/quick response code pattern only after downloading an appropriate application;

2. the clarity of the two-dimensional barcode/quick response code pattern;

3. the light for scanning the two-dimensional barcode/quick response code pattern;

4. the distance for scanning the two-dimensional barcode/quick response code pattern;

5. the two-dimensional barcode/quick response code pattern is not uniform in size and its attachment may affect the aesthetic appearance of an advertising board;

6. with each two-dimensional barcode/quick response code pattern corresponding to one URL electronic data, there are numerous two-dimensional barcode/quick response code patterns present so as to meet the market demand, which can be expected to lead to chaos; and

7. the two-dimensional barcode/quick response code pattern is embedded into a screen picture of a video product or a webpage;

(1) during actual operation, the time for an electronic screen to display the two-dimensional barcode/quick response code pattern is very short, and it is difficult for a user to conduct the operation;

(2) in case of a non-high definition video image, the two-dimensional barcode/quick response code pattern is caused to distort and thus becomes unreadable; and

(3) in case of wobbling public transportation, the two-dimensional barcode/quick response code pattern is very difficult to read.

It is particularly emphasized that the solution of two-dimensional barcode/quick response code patterns is less competent to address the connection involving an audio/video product (an audio information technology).

Today, science and technology have entered into the era of human-computer interaction. In the public places of major cities, with the convergence between mobile networks and fixed networks, information accessibility is a technical barrier that cannot be crossed out for accessing the Internet anytime anywhere through a smart phone and achieving the development goal of smart cities.

As an important part of the new generation of information technology, the Internet of Things has been widely applied to network convergence, and thus is also known as the third wave following computer and Internet, in the development of the information industry around the world.

First, the Internet of Things still takes Internet as its core and foundation, and it is a network extending and expanding based on the Internet; and second, the clients of the Internet of Things have extended and expanded among any items for information exchange and communication, that is, things are closely linked.

As the Internet of Things technology develops continuously, there is an inevitable development trend of deep convergence between traditional industries and Internet technologies.

Therefore, there is an urgent expectation from the market to meet the requirements anytime anywhere at will with an easier, faster and more efficient Internet of Things technology.

### BRIEF SUMMARY OF THE INVENTION

To achieve the object above, the present invention provides a PTP interactive interconnected system for setting a URL electronic data device, comprising a communication terminal product supporting the PTP interactive interconnected system, a URL electronic data device, and a plane mark, wherein the communication terminal product supports a remote communication function; the communication terminal product supports a short distance communication function; the URL electronic data device stores a URL electronic data combination; the plane mark is a numeric character; the communication terminal product supports the input of a numeric character corresponding to the plane mark; and an operating system of the communication terminal product receives an instruction from the plane mark, calls out paired URL electronic data stored in the URL electronic data device, and sends a relevant request to a back-end server after processing the paired URL electronic data, and the back-end server returns an electronic file associated with the URL electronic data according to the relevant request.

The communication terminal product supports the remote communication function, and requests a connected telecommunication network to return an electronic file associated with the URL electronic data.

The communication terminal product supports WIFI (Wireless Fidelity) technology, and requests a connected WIFI device to return an electronic file associated with the URL electronic data.

The short distance communication function of the communication terminal product supports Bluetooth technology.

The short distance communication function of the communication terminal product supports a kind of NFC (Near Field Communication) technology.

The URL electronic data device consists of a built-in URL electronic data device and a trigger URL electronic data device.

The built-in URL electronic data device equipped in the communication terminal product, and the built-in URL electronic data device stores a raw URL electronic data combination.

The trigger URL electronic data device is equipped in the communication terminal product, activates the raw URL electronic data combination stored in the built-in URL electronic data device based on a condition set by the communication terminal product, and transforms the raw URL electronic data combination into another new set of URL electronic data combination.

The trigger URL electronic data device is an external NFC product, activates the raw URL electronic data combination stored in the built-in URL electronic data device of the communication terminal product based on a contacting working state between the communication terminal product and the external NFC product, and transforms the raw URL electronic data combination into another new set of URL electronic data combination.

The numeric character of the plane mark is correspondingly paired with the URL electronic data combination stored in the URL electronic data device.

The technology of the present invention is a PTP (Point to Page of Internet) interactive interconnected system for setting a URL electronic data device, and provides technical support enabling the deep convergence between traditional industries and Internet technologies, and achieved Internet Plus.

1. The technology of the present invention employs the URL electronic data of the international standard technology as a media technology for the interactive interconnected system, and the communication terminal product supports the input of the corresponding numeric character according to the plane mark, truly enabling barrier-free connection.

2. With the simplest point to point connection technology, a new technical direction of solution is provided regarding the big data congestion problem confronted by the development of the Internet.

3. The URL electronic data stored in the URL electronic data device designed by the present invention is an raw URL electronic data combination, which may change as required through the functional support of the trigger URL electronic data device, either meeting numerous user requirements in the market or preventing the chaos caused by the overlapping of plane marks.

The present invention is obviously superior to the solution of two-dimensional barcode/quick response code patterns in the market and the relevant solutions of connection technologies in terms of both operation and effect, thereby meeting the vision of obtaining information anytime anywhere at will in the era of mobile information.

### BRIEF DESCRIPTION OF THE SEVERAL VIEWS OF THE DRAWINGS

FIG. 1 is a schematic diagram of a structure of a URL electronic data device;

FIG. 2A is a schematic diagram 1 of a working principle of the URL electronic data device;

FIG. 2B is a schematic diagram 2 of a working principle of the URL electronic data device;

FIG. 3A is a schematic diagram of a plane media product employing a two-dimensional barcode/quick response code pattern;

FIG. 3B is a schematic diagram of a plane media product employing an NFC module;

FIG. 3C is a schematic diagram 1 of an effect of a plane media product employing a technology of the present invention;

FIG. 3D is a schematic diagram 2 of an effect of a plane media product employing the technology of the present invention;

FIG. 4A is a schematic diagram of a point to point application of the technology of the present invention; and

FIG. 4B is a schematic diagram of a point to point effect of the technology of the present invention.

### DETAILED DESCRIPTION OF THE INVENTION

The following embodiments are intended to further explain and illustrate the present invention, instead of setting any limit to the present invention.

The present invention provides a PTP interactive interconnected system for setting a URL electronic data device, comprising a communication terminal product 38 supporting the PTP interactive interconnected system, a URL electronic data device 90, and a plane mark, wherein the communication terminal product supports a remote communication function; the communication terminal product supports a short distance communication function; the URL electronic data device 90 stores an URL electronic data combination; the plane mark is a numeric character; the communication terminal product supports the input of a numeric character corresponding to the plane mark; and an operating system of the communication terminal product receives an instruction from the plane mark, calls out paired URL electronic data stored in the URL electronic data device 90, and sends a relevant request to a back-end server after processing the paired URL electronic data, and the back-end server returns an electronic file associated with the URL electronic data according to the relevant request.

The communication terminal product supports the remote communication function, and requests a connected telecommunication network to return an electronic file associated with the URL electronic data.

The communication terminal product supports WIFI (Wireless Fidelity) technology, and requests a connected WIFI device to return an electronic file associated with the URL electronic data.

The returned electronic file is browsed through a display screen of the communication terminal product.

The short distance communication function of the communication terminal product supports Bluetooth technology, and obtains the URL electronic data from a relevant external product.

The short distance communication function of the communication terminal product supports a kind of NFC (Near Field Communication) technology, and obtains the URL electronic data from an external NFC product.

The URL electronic data device 90 consists of a built-in URL electronic data device 91 and a trigger URL electronic data device 92.

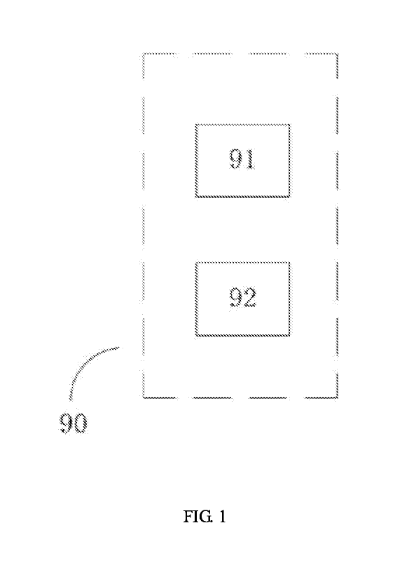

As shown in FIG. 1, the built-in URL electronic data device is equipped in the communication terminal product. The built-in URL electronic data device stores an raw URL electronic data combination.

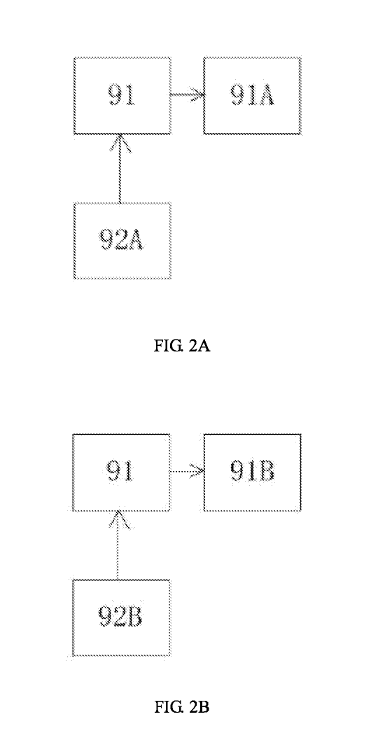

As shown in FIG. 2 in series, the trigger URL electronic data device is equipped in the communication terminal product. The trigger URL electronic data device activates the raw URL electronic data combination stored in the built-in URL electronic data device 91 based on a condition set by the communication terminal product, and transforms the raw URL electronic data combination into another new set of URL electronic data combination.

Not only can numerous user requirements in the market be met, but also the chaos caused by the overlapping of plane marks is prevented.

As shown in FIG. 2A, a design solution of the present embodiment is as follows: the raw URL electronic data combination of the built-in URL electronic data device 91 is a series of “0000+(0001˜9999)”; the trigger URL electronic data device 92 A has the URL electronic data of “0001”, activates the raw URL electronic data combination stored in the built-in URL electronic data device 91 of the communication terminal product and transforms the raw URL electronic data combination into another new set of URL electronic data combination; and the raw URL electronic data combination is transformed from the series of “0000+(0001˜9999)” into the series of “0001+(0001˜9999)”.

As shown in FIG. 2B, a design solution of the present embodiment is as follows: the original URL electronic data combination of the built-in URL electronic data device 91 is a series of “0000+(0001˜9999)”; the trigger URL electronic data device 92 B has the URL electronic data of “0033”, activates the raw URL electronic data combination stored in the built-in URL electronic data device 91 of the communication terminal product and transforms the raw URL electronic data combination into another new set of URL electronic data combination; and the raw URL electronic data combination is transformed from the series of “0000+(0001˜9999)” into the series of “0033+(0001˜9999)”.

The trigger URL electronic data device 92 is an external NFC product 93, activates the raw URL electronic data combination stored in the built-in URL electronic data device 91 of the communication terminal product based on a contacting working state between the communication terminal product and the external NFC product 93, and transforms the raw URL electronic data combination into another new set of URL electronic data combination.

The numeric character of the plane mark is correspondingly paired with the URL electronic data combination stored in the URL electronic data device 90.

The plane mark may be from different sources, including traditional paper-made newspapers and periodicals, paper-made books, advertising boards of plane media, traffic boards on public roads, publication and guide boards for public tourism, guide boards for emergency services, public bus shelters, taxi call service shelters, bank logos and the like.

URL electronic data links are sourced from various aspects, including memory, cloud storage, webpages based on login settings and the like, and the relevant technologies will not be explained in detail any more since they are extremely conventional and common in the market.

Relevant technical solutions and the application of the technology of the present invention are compared as follows:

to improve the transmission effect of the print media products, there have been different technical solutions in the market, including the solution of two-dimensional barcode/quick response code patterns, the solution of NFC technology and the solution of RFID technology and the like.

The information contents of the plane media products (such as advertising boards for public promotion and public traffic symbols) are based on a plane information technology, and a user needs to enter a website to conduct a connection operation if he/she wants to obtain the further information content of the print media products, which is quite troublesome.

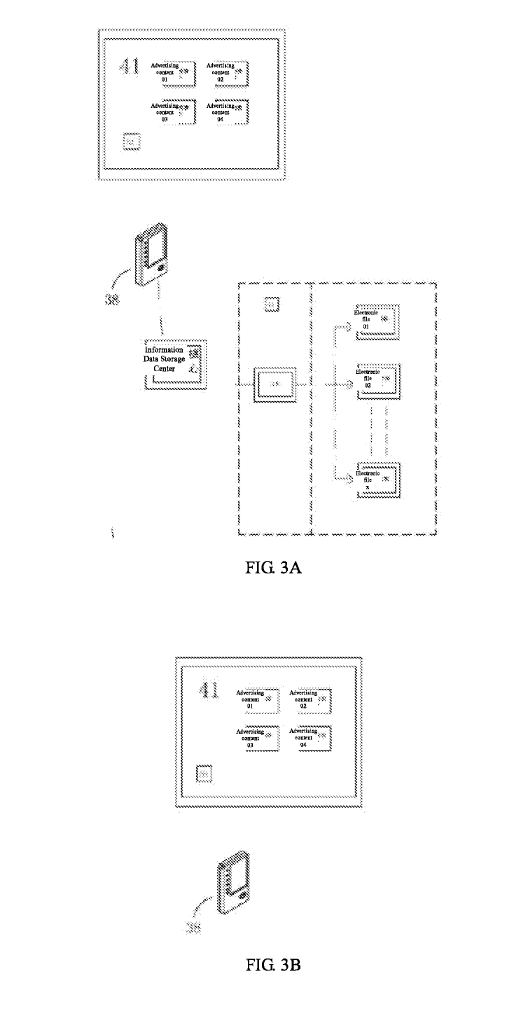

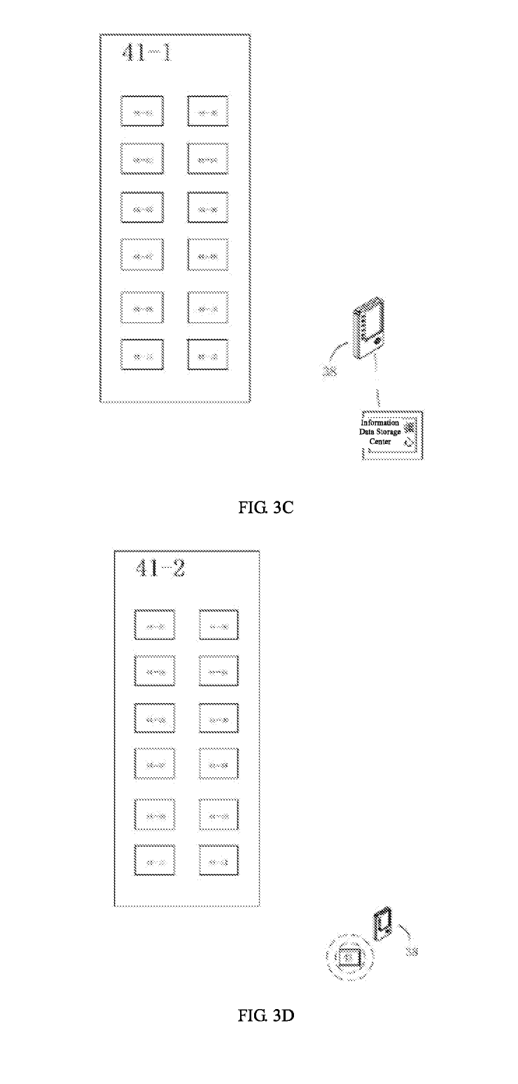

As shown in FIG. 3A, the traditional plane media product is embedded with a two-dimensional barcode/quick response code pattern 52 (a plane information technology) to enable a visitor to log on to a website of the relevant electronic address data and follow the relevant advertising content, with the steps as follows:

1. scanning a two-dimensional barcode/quick response code pattern and processing and transforming the same into URL electronic data, through a smart phone;

2. logging on to the website of the relevant URL electronic data, and

3. conducting a traditional webpage search operation.

As shown in FIG. 3B, the traditional plane media product is simultaneously embedded with an NFC module 53 (an electronic information technology) to enable a visitor to quickly log on to a website of the relevant electronic address data and follow the relevant advertising content, with the steps as follows:

1. approaching the NFC module through a smart phone to obtain URL electronic data;

2. logging on to the website of the relevant URL electronic data, and

3. conducting a traditional webpage search operation.

A very short distance is supported only based on the NFC technology, and when a visitor conducts an operation, other visitors may be obstructed from conducting the operation (including a visit sight).

The following provides relevant embodiments of the technology of the present invention.

As shown in FIG. 3C, in Embodiment 1, after a plane media product employs the technology of the present invention, a corresponding numeric character 03 is entered into the communication terminal product 38 (a smart phone) according to an identification mark (a guide) of the plane media product; and the operating system of the communication terminal product receives an instruction from the plane mark, calls out URL electronic data paired with 03 and stored in the URL electronic data device 90, and sends a relevant request to a back-end server after processing the paired URL electronic data, the back-end server returns an electronic file associated with the URL electronic data of 03 according to the relevant request, and the electronic file is browsed through a display screen of the communication terminal product.

As shown in FIG. 3D, in Embodiment 2, after a plane media product employs the technology of the present invention, a corresponding numeric character 03 is entered into the communication terminal product 38 (a smart phone) according to an identification mark (a guide) of the plane media product; and the operating system of the communication terminal product receives an instruction from the plane mark, calls out URL electronic data paired with 03 and stored in the URL electronic data device 90, and sends a relevant request to a back-end server after processing the paired URL electronic data, the back-end server returns an electronic file associated with the URL electronic data of 03 according to the relevant request, and the electronic file is browsed through a display screen of the communication terminal product.

It is particularly indicated that the original URL electronic data combination of the built-in URL electronic data device 91 of the communication terminal product has been activated and transformed into another new set of URL electronic data combination, and thus, the electronic file here may be a different file compared with the electronic file associated with the URL electronic data of 03 and returned in Embodiment 1.

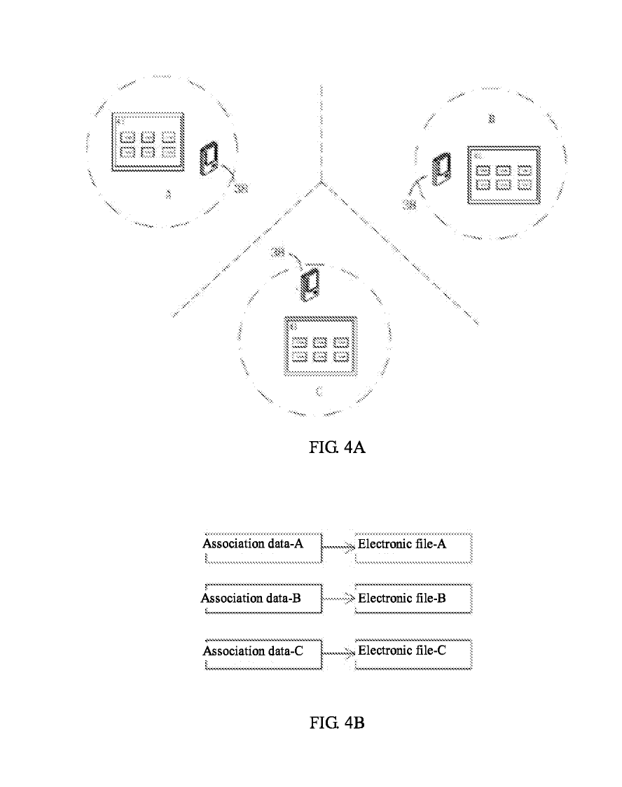

As shown in FIG. 4A, in Embodiment 3, in the event that a large company holds a city-wide marketing and promotion activity which employs a uniform design for a plane advertising content, consumers from different locations of promotion regions may obtain specific activity data regarding branches from different regions.

As shown in FIG. 4B, in region A, a consumer obtains associated data A corresponding to a numeric character (an identification mark) through a smart phone, where the associated data A corresponds to the relevant electronic information provided by a branch from region A.

But in region B, a consumer obtains associated data B corresponding to a numeric character (an identification mark) through a smart phone, where the associated data B corresponds to the relevant electronic information provided by a branch from region B.

However, in region C, a consumer obtains associated data C corresponding to a numeric character (an identification mark) through a smart phone, where the associated data C corresponds to the relevant electronic information provided by a branch from region C.

The technology of the present invention provides a technical solution having a category different from that of the solution of two-dimensional barcode/quick response code patterns, and thus has distinct effects as follows:

1. basically no limit from distance;

2. basically no impact from light conditions;

3. accuracy superior to that of the solution of two-dimensional barcode/quick response code patterns; and

4. fewer impacts to the aesthetic appearance of an advertising board due to substitution of the two-dimensional barcode/quick response code pattern with the numeric character.

With reference to the effects of the relevant embodiments above, the technology of the present invention is obviously superior in terms of operation, fabrication cost and transmission effect compared with relevant technical solutions and product solutions in the market, and the present invention will be further developed to affect all the links of a commercial chain and create a brand-new form of commercial mode and value chain.

Though the technology of the present invention is disclosed with the embodiments above, the scope of the technology of the present invention is not limited thereto, and all the components above may be substituted with other similar or equivalent elements known to those skilled in the art without departing from the conception of the technology of the present invention.

1. A PTP interactive interconnected system for setting a URL electronic data device, comprising a communication terminal product supporting the PTP interactive interconnected system, a URL electronic data device, and a plane mark, wherein
the communication terminal product supports a remote communication function;
the communication terminal product supports a short distance communication function;
the URL electronic data device stores an URL electronic data combination;
the plane mark is a numeric character;
the communication terminal product supports the input of a numeric character corresponding to the plane mark; and
an operating system of the communication terminal product receives an instruction from the plane mark, calls out paired URL electronic data stored in the URL electronic data device, and sends a relevant request to a back-end server after processing the paired URL electronic data, and the back-end server returns an electronic file associated with the URL electronic data according to the relevant request.

2. The PTP interactive interconnected system for setting the URL electronic data device of claim 1, wherein the communication terminal product supports the remote communication function, and requests a connected telecommunication network to return an electronic file associated with the URL electronic data.

3. The PTP interactive interconnected system for setting the URL electronic data device of claim 1, wherein the communication terminal product supports WIFI (Wireless Fidelity) technology, and requests a connected WIFI device to return an electronic file associated with the URL electronic data.

4. The PTP interactive interconnected system for setting the URL electronic data device of claim 1, wherein the short distance communication function of the communication terminal product supports Bluetooth technology.

5. The PTP interactive interconnected system for setting the URL electronic data device of claim 1, wherein the short distance communication function of the communication terminal product supports a kind of NFC (Near Field Communication) technology.

6. The PTP interactive interconnected system for setting the URL electronic data device of claim 1, wherein the URL electronic data device consists of a built-in URL electronic data device and a trigger URL electronic data device.

7. The PTP interactive interconnected system for setting the URL electronic data device of claim 6, wherein the built-in URL electronic data device is equipped in the communication terminal product, and the built-in URL electronic data device stores an raw URL electronic data combination.

8. The PTP interactive interconnected system for setting the URL electronic data device of claim 6, wherein the trigger URL electronic data device is equipped in the communication terminal product, activates the raw URL electronic data combination stored in the built-in URL electronic data device based on a condition set by the communication terminal product, and transforms the raw URL electronic data combination into another new set of URL electronic data combination.

9. The PTP interactive interconnected system for setting the URL electronic data device of claim 6, wherein the trigger URL electronic data device is an external NFC product, activates the raw URL electronic data combination stored in the built-in URL electronic data device of the communication terminal product based on a contacting working state between the communication terminal product and the external NFC product, and transforms the raw URL electronic data combination e into another new set of URL electronic data combination.

10. The PTP interactive interconnected system for setting the URL electronic data device of claim 1, wherein the numeric character of the plane mark is correspondingly paired with the URL electronic data combination stored in the URL electronic data device.
